(19) United States
(12) Patent Application Publication
(10) Pub. No.: US 2025/0226147 A1
(43) Pub. Date: Jul. 10, 2025

(54) COIL AND MAGNETIC COMPONENT

(71) Applicant: KABUSHIKI KAISHA TOSHIBA, Tokyo (JP)

(72) Inventor: Keigo ARITA, Kawasaki (JP)

(73) Assignee: KABUSHIKI KAISHA TOSHIBA, Tokyo (JP)

(21) Appl. No.: 18/969,561

(22) Filed: Dec. 5, 2024

(30) Foreign Application Priority Data
Jan. 4, 2024 (JP) 2024-000338

(51) Int. Cl. H01F 27/32; H01F 1/34

(52) U.S. Cl. CPC H01F 27/32; H01F 1/344

(57) ABSTRACT

According to one embodiment, a coil includes a conductive member, and a first magnetic sheet. The conductive member is wound around a first axis as a center. The conductive member includes a first partial region and a second partial region. A first direction from the first partial region to the second partial region is along the first axis. The first magnetic sheet includes a first sheet region. The first sheet region is provided between the first partial region and the second partial region in the first direction.

### CROSS-REFERENCE TO RELATED APPLICATIONS

This application is based upon and claims the benefit of priority from Japanese Patent Application No. 2024-000338, filed on Jan. 4, 2024; the entire contents of which are incorporated herein by reference.

### FIELD

Embodiments described herein relate generally to a coil and a magnetic component.

### BACKGROUND

For example, a coil including a wound conductive member is used for magnetic components and the like. It is desirable to reduce loss in the coil.

### BRIEF DESCRIPTION OF THE DRAWINGS

FIGS. 1A to 1C are schematic views illustrating a coil according to a first embodiment;

FIG. 2 is a graph illustrating the characteristics of the coil;

FIG. 3 is a schematic cross-sectional view illustrating a coil according to the first embodiment;

FIG. 4 is a schematic cross-sectional view illustrating a part of a coil according to the first embodiment; and

FIGS. 5A and 5B are schematic views illustrating a coil according to the first embodiment.

### DETAILED DESCRIPTION

According to one embodiment, a coil includes a conductive member, and a first magnetic sheet. The conductive member is wound around a first axis as a center. The conductive member includes a first partial region and a second partial region. A first direction from the first partial region to the second partial region is along the first axis. The first magnetic sheet includes a first sheet region. The first sheet region is provided between the first partial region and the second partial region in the first direction.

Various embodiments are described below with reference to the accompanying drawings.

The drawings are schematic and conceptual; and the relationships between the thickness and width of portions, the proportions of sizes among portions, etc., are not necessarily the same as the actual values. The dimensions and proportions may be illustrated differently among drawings, even for identical portions.

In the specification and drawings, components similar to those described previously or illustrated in an antecedent drawing are marked with like reference numerals, and a detailed description is omitted as appropriate.

### First Embodiment

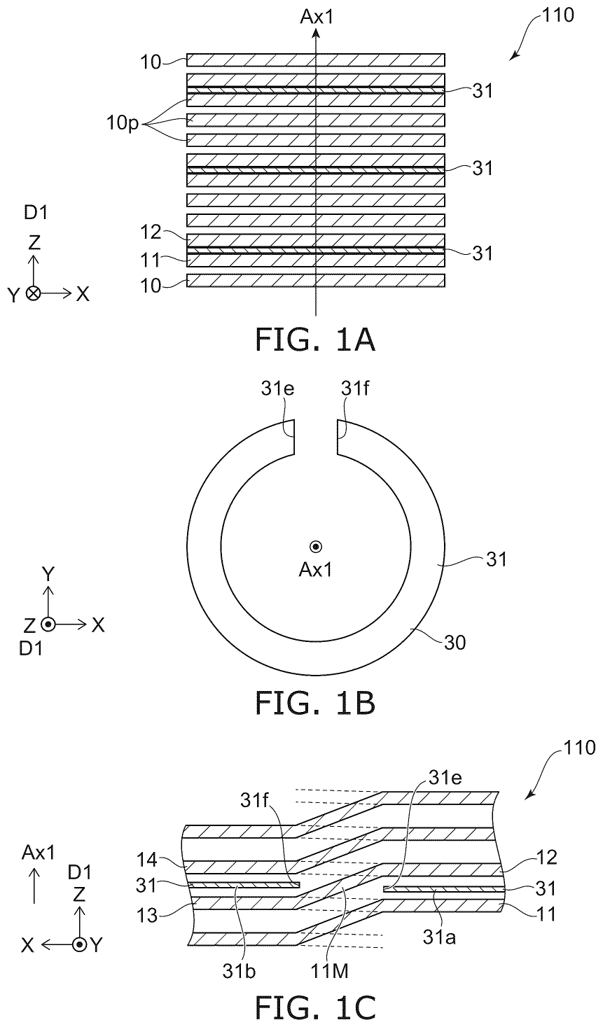

FIGS. 1A to 1C are schematic views illustrating the coil according to a first embodiment.

FIG. 1A is a side view. FIG. 1B is a plan view of a part of the coil. FIG. 1C is an enlarged cross-sectional view of a part of the coil.

As shown in FIGS. 1A to 1C, a coil 110 according to the embodiment includes a conductive member 10 and a first magnetic sheet 31.

The conductive member 10 is wound around a first axis Ax1 as a center. The conductive member 10 is, for example, a wound wire. The conductive member 10 may be a conductive wire, a conductive layer, or the like. For example, the conductive member 10 is spirally wound around the first axis Ax1 as a center. As shown in FIG. 1C, the conductive member 10 includes a plurality of partial regions 10p (for example, a first partial region 11 and a second partial region 12). These partial regions 10p correspond to a plurality of part of the spiral conductive member 10 that are wound at different positions. A first direction D1 from the first partial region 11 to the second partial region 12 is along the first axis Ax1.

The first magnetic sheet 31 includes a first sheet region 31a. The first sheet region 31a is provided between the first partial region 11 and the second partial region 12 in the first direction D1.

In the coil 110 according to the embodiment, the first sheet region 31a of the first magnetic sheet 31 is provided between the first partial region 11 and the second partial region 12. The first sheet region 31a functions, for example, as a magnetic shield. Thereby, magnetic interaction between the first partial region 11 and the second partial region 12 is suppressed. For example, losses due to proximity effects are suppressed. According to the embodiment, a coil that can reduce loss can be provided.

For example, the magnetic field caused by the current flowing through the first partial region 11 is suppressed from being applied to the second partial region 12. For example, the magnetic field caused by the current flowing through the second partial region 12 is suppressed from being applied to the first partial region 11.

As shown in FIG. 1C, the conductive member 10 may further include a third partial region 13 and a fourth partial region 14. The third partial region 13 is provided between the first partial region 11 and the second partial region 12. The third partial region 13 is provided, for example, between the first partial region 11 and the second partial region 12 in the direction along the winding. The second partial region 12 is provided between the third partial region 13 and the fourth partial region 14. The second partial region 12 is provided, for example, between the third partial region 13 and the fourth partial region 14 in the direction along the winding. For example, the current flowing through the conductive member 10 flows from the first partial region 11 to the third partial region 13, from the third partial region 13 to the second partial region 12, and from the second partial region 12 to the fourth partial region 14. Alternatively, the current flowing through the conductive member 10 flows from the fourth partial region 14 to the second partial region 12, from the second partial region 12 to the third partial region 13, and from the third partial region 13 to the first partial region 11.

A direction from the third partial region 13 to the fourth partial region 14 is along the first direction D1. The first magnetic sheet 31 may further include a second sheet region 31b. The second sheet region 31b is provided between the third partial region 13 and the fourth partial region 14. The second sheet region 31b functions, for example, as a magnetic shield. Thereby, magnetic interaction between the third partial region 13 and the fourth partial region 14 is suppressed. Loss can be reduced.

For example, a direction from the third partial region 13 to the first partial region 11 crosses the first direction D1.

The first direction D1 is defined as a Z-axis direction. One direction perpendicular to the Z-axis direction is defined as an X-axis direction. A direction perpendicular to the Z-axis direction and the X-axis direction is defined as a Y-axis direction.

In this example, the first magnetic sheet 31 has a flat shape. A part of the first magnetic sheet 31 does not overlap another part of the first magnetic sheet 31 in the first direction D1. In this example, the first magnetic sheet 31 has a planar shape along the X-Y plane. As will be described later, the shape of the first magnetic sheet 31 can be modified in various ways.

FIG. 1B illustrates the planar shape of the first magnetic sheet 31. The first magnetic sheet 31 may have an arc shape centered on the first axis Ax1, for example. The arc is, for example, a partially interrupted circular ring shape. The width of the arc has a length greater than or equal to the width of the conductive member 10, for example. The planar shape of the first magnetic sheet 31 may be a shape corresponding to the shape of the conductive member 10. The shape of the first magnetic sheet 31 may be, for example, a shape in which a polygonal ring is interrupted. In a plan view along the first direction D1, the conductive member 10 is located between the outer edge and the inner edge of the first magnetic sheet 31.

As shown in FIG. 1B, the first magnetic sheet 31 does not have to be annular. The first magnetic sheet 31 includes a first end 31e and a first other end 31f. A gap is provided between the first end 31e and the first other end 31f. A part of the conductive member 10 may pass through the gap.

As shown in FIG. 1C, the conductive member 10 further includes a first intermediate region 11M between the second partial region 12 and the third partial region 13. The first intermediate region 11M is provided between the first end 31e and the first other end 31f. The first magnetic sheets 31 may be provided to sandwich the first intermediate region 11M. The function of the first magnetic sheet 31 as a magnetic shield is effectively exhibited.

In the example of FIG. 1C, a direction from the second sheet region 31b to the first sheet region 31a is substantially perpendicular to the first direction D1. The angle between the direction from the second sheet region 31b to the first sheet region 31a and the first direction D1 may be, for example, not less than 82 degrees and not more than 98 degrees.

In the example of FIG. 1C, the direction from the third partial region 13 to the second partial region 12 is inclined with respect to the first direction D1. For example, the direction along the third partial region 13 is inclined with respect to the direction along the first intermediate region 11M. The direction along the third partial region 13 is substantially parallel to the direction along the second partial region 12.

As shown in FIG. 1A, the conductive member 10 includes a plurality of partial regions 10p. The first partial region 11, the second partial region 12, the third partial region 13, the fourth partial region 14, the first intermediate region 11M, etc. are included in the plurality of partial regions 10p.

A plurality of first magnetic sheets 31 may be provided. In the embodiment, the partial regions 10p and the first magnetic sheets 31 may be provided alternately in the first direction D1.

In the example of FIG. 1A, in the first direction D1, two or more of the plurality of partial regions 10p are provided between one of the plurality of first magnetic sheets 31 and another one of the plurality of first magnetic sheets 31. The two or more of the plurality of partial regions 10p include, for example, one of the plurality of partial regions 10p and another one of the plurality of partial regions 10p. The direction from one of the plurality of partial regions 10p to another one of the plurality of partial regions 10p is along the first direction D1.

For example, the first partial region 11 may be included in one of the plurality of partial regions 10p. The second partial region 12 may be included in another one of the plurality of partial regions 10p. Magnetic interaction between one of the plurality of partial regions 10p and another one of the plurality of partial regions 10p is suppressed. For example, losses due to proximity effects are suppressed. According to the embodiment, a coil that can reduce loss can be provided.

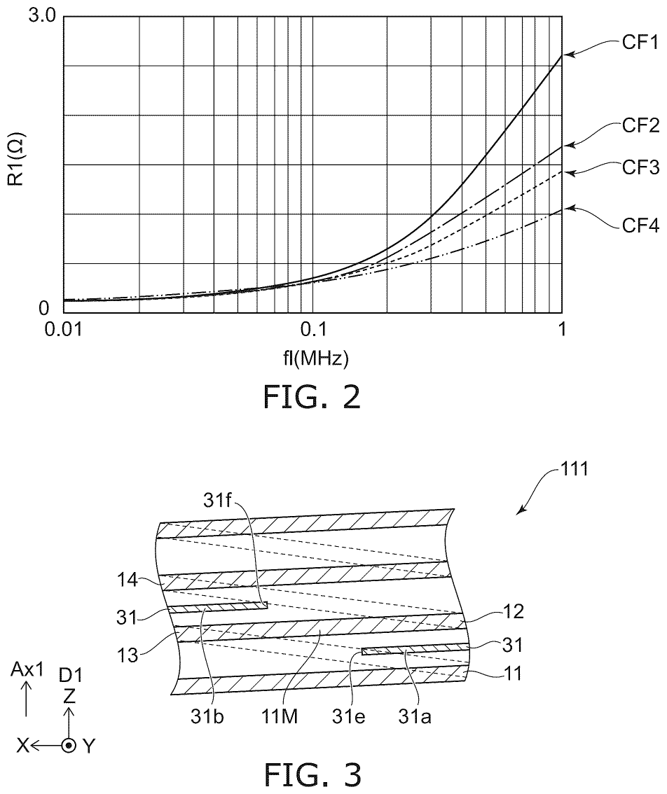

FIG. 2 is a graph illustrating the characteristics of the coil.

FIG. 2 illustrates characteristics in a plurality of coil configurations (first configuration CF1, second configuration CF2, third configuration CF3, and fourth configuration CF4). In the first configuration CF1, the first magnetic sheet 31 is not provided. In the second configuration CF2, one first magnetic sheet 31 is provided for every eight turns of the conductive member 10. In the third configuration CF3, one first magnetic sheet 31 is provided for every four turns of the conductive member 10. In the fourth configuration CF4, one first magnetic sheet 31 is provided for each turn of the conductive member 10. The horizontal axis in FIG. 2 is frequency f1. The vertical axis is AC resistance R1 of the coil.

As shown in FIG. 2, the AC resistance R1 in the second configuration CF2, third configuration CF3, and fourth configuration CF4 is lower than the AC resistance R1 in the first configuration CF1. By providing the first magnetic sheet 31, loss can be reduced. Since the first magnetic sheet 31 has a gap, the first magnetic sheet 31 can be inserted into a desired position of the coil with a desired number of turns. If the frequency of insertion of the first magnetic sheet 31 is high, a low AC resistance R1 can be obtained. The frequency may be determined depending on the target loss, production efficiency, etc.

A part of the conductive member 10 overlaps another part of the conductive member 10 in the first direction D1. The conductive member 10 has a configuration of two or more layers that overlap in the first direction D1. The conductive member 10 may be wound multiple times in each of the multiple layers. The conductive member 10 may include, for example, an edgewise coil. The conductive member 10 may have, for example, a structure in which a rectangular metal wire is wound once in one layer. The thickness of the rectangular metal wire is the length of the rectangular metal wire along the first direction D1. The width of the rectangular metal wire is the length of the rectangular metal wire along a direction perpendicular to the winding direction of the rectangular metal wire and perpendicular to the first direction D1. For example, the width of the rectangular metal wire is greater than the thickness of a rectangular metal wire. In a plan view along the first direction D1, the conductive member 10 may be wound in a substantially polygonal or circular shape.

FIG. 3 is a schematic cross-sectional view illustrating a coil according to the first embodiment.

As shown in FIG. 3, a coil 111 according to the embodiment also includes the conductive member 10 and the first magnetic sheet 31. In the coil 111, the cross-sectional shapes of the conductive member 10 and the first magnetic sheet 31 are different from those in the coil 110. The configuration of the coil 111 other than this may be the same as the configuration of the coil 110.

In the coil 111, the direction from the second sheet region 31b to the first sheet region 31a is inclined with respect to the first direction D1. The direction along the third partial region 13 is substantially parallel to the direction along the first intermediate region 11M. The direction along the first intermediate region 11M is substantially parallel to the direction along the second partial region 12. In this way, in the embodiments, the cross-sectional shape can be modified in various ways.

In the embodiment, the conductive member 10 includes, for example, at least one selected from the group consisting of Cu, Al, Ag, and Au. The first magnetic sheet 31 includes, for example, at least one selected from the group consisting of Fe, Co, Ni, and Mn. For example, the first magnetic sheet 31 may include ferrite.

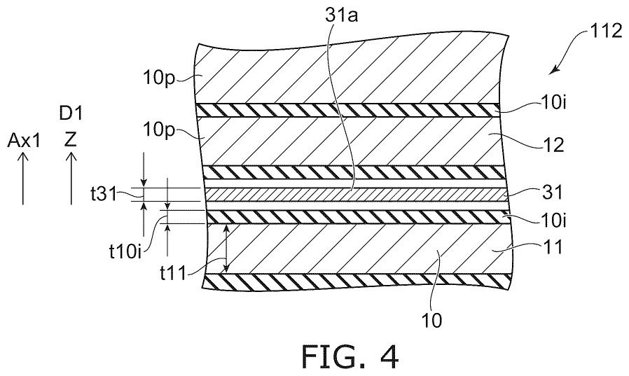

FIG. 4 is a schematic cross-sectional view illustrating a part of a coil according to the first embodiment.

As shown in FIG. 4, a coil 112 according to the embodiment further includes an insulating member 10i. At least a part of the insulating member 10i is provided between the first partial region 11 and the first sheet region 31a. The insulating member 10i may be provided between one of the plurality of partial regions 10p and another one of the plurality of partial regions 10p.

As shown in FIG. 4, a thickness t31 of the first magnetic sheet 31 along the first direction D1 may be thinner than a thickness t11 of the first partial region 11 along the first direction D1. For example, by the thickness t11 being thick, it is easy to obtain low electrical resistance.

In one example, the thickness t31 of the first magnetic sheet 31 along the first direction D1 is not less than 10 μm and not more than 100 μm. In one example, the thickness t11 of the first partial region 11 along the first direction D1 is not less than 50 μm and not more than 200.

A thickness t10i of the insulating member 10i along the first direction D1 is, for example, not less than 20 μm and not more than 100 μm. The insulating member 10i may include, for example, resin (polyimide, vinyl chloride, polyethylene, etc.). The insulating member 10i may include, for example, paint (enamel, polyurethane, etc.).

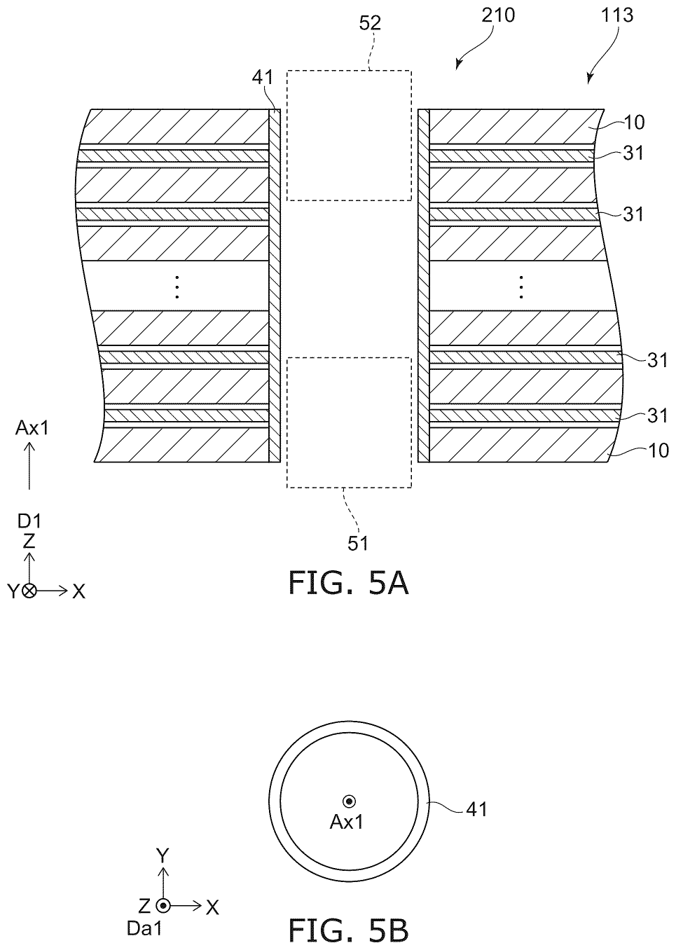

FIGS. 5A and 5B are schematic views illustrating a coil according to the first embodiment.

FIG. 5A is a cross-sectional view. FIG. 5B is a plan view of a part of the coil.

As shown in FIG. 5A, a coil 113 according to the embodiment further includes a first magnetic member 41 in addition to the conductive member 10 and the first magnetic sheet 31. The configuration of the coil 113 other than this may be the same as the configuration of the coil 110, the coil 111, or the coil 112.

FIG. 5B illustrates the planar shape of the first magnetic member 41. The first magnetic member 41 has, for example, a cylindrical shape centered on the first axis Ax1. The conductive member 10 is wound around the first magnetic member 41 in a first plane crossing the first axis Ax1. The first plane is, for example, the X-Y plane. The first magnetic sheet 31 is provided around the first magnetic member 41 in the first plane (the X-Y plane).

For example, as illustrated in FIG. 5A, the influence of fringe magnetic flux between the first core 51 (magnetic core) and the second core 52 (magnetic core) is suppressed. Losses are reduced.

The first magnetic member 41 may include, for example, at least one selected from the group consisting of Fe, Co, Ni, and Mn.

### Second Embodiment

The second embodiment relates to a magnetic component. A magnetic component 210 according to the second embodiment (see FIG. 5A) includes the coil (one of the coils 110 to 113, etc.) according to the first embodiment, the core (the first core 51 or second core 52, etc.). The conductive member 10 is wound around the core. The first magnetic sheet 31 is provided around the core. In the magnetic component 210 according to the embodiment, loss is suppressed and high efficiency is obtained.

The embodiments may include, for example, the following technical proposals:

### (Technical Proposal 1)

A coil, comprising:
a conductive member wound around a first axis as a center, the conductive member including a first partial region and a second partial region, a first direction from the first partial region to the second partial region being along the first axis; and
a first magnetic sheet including a first sheet region, the first sheet region being provided between the first partial region and the second partial region in the first direction.

### (Technical Proposal 2)

The coil according to Technical proposal 1, wherein
the conductive member further includes a third partial region and a fourth partial region,
the third partial region is provided between the first partial region and the second partial region,
the second partial region is provided between the third partial region and the fourth partial region,
a direction from the third partial region to the fourth partial region is along the first direction,
the first magnetic sheet further includes a second sheet region, and
the second sheet region is provided between the third partial region and the fourth partial region.

### (Technical Proposal 3)

The coil according to Technical proposal 2, wherein
a direction from the third partial region to the first partial region crosses the first direction.

### (Technical Proposal 4)

The coil according to Technical proposal 2 or 3, wherein
the first magnetic sheet includes a first end and a first other end,
the conductive member further includes a first intermediate region between the second partial region and the third partial region, and
the first intermediate region is provided between the first end and the first other end.

### (Technical Proposal 5)

The coil according to any one of Technical proposals 2-4, wherein
a direction from the second sheet region to the first sheet region is substantially perpendicular to the first direction.

### (Technical Proposal 6)

The coil according to Technical proposal 5, wherein
a direction from the third partial region to the second partial region is inclined with respect to the first direction.

### (Technical Proposal 7)

The coil according to Technical proposal 4, wherein
a direction along the third partial region is inclined with respect to a direction along the first intermediate region, and
a direction along the third partial region is substantially parallel to a direction along the second partial region.

### (Technical Proposal 8)

The coil according to any one of Technical proposals 2-4, wherein
a direction from the second sheet region to the first sheet region is inclined with respect to the first direction.

### (Technical Proposal 9)

The coil according to Technical proposal 4, wherein
a direction along the third partial region is substantially parallel to a direction along the first intermediate region, and
the direction along the first intermediate region is substantially parallel to a direction along the second partial region.

### (Technical Proposal 10)

The coil according to any one of Technical proposals 1-9, wherein
the first magnetic sheet has an arc shape with the first axis as the center.

### (Technical Proposal 11)

The coil according to any one of Technical proposals 1-10, further comprising:
a first magnetic member,
the first magnetic member having a cylindrical shape with the first axis as the center,
the conductive member being wound around the first magnetic member in a first plane crossing the first axis, and
the first magnetic sheet being provided around the first magnetic member on the first plane.

### (Technical Proposal 12)

The coil according to Technical proposal 11, wherein
the first magnetic member includes at least one selected from the group consisting of Fe, Co, Ni, and Mn.

### (Technical Proposal 13)

The coil according to any one of Technical proposals 1-12, wherein
the conductive member includes a plurality of partial regions,
a plurality of the first magnetic sheets are provided, and
the partial region and the first magnetic sheet are alternately provided in the first direction.

### (Technical Proposal 14)

The coil according to any one of Technical proposals 1-13, wherein
the conductive member includes a plurality of partial regions,
a plurality of the first magnetic sheets are provided,
in the first direction, one of the plurality of partial regions and another of the plurality of partial regions are provided between one of the plurality of first magnetic sheets and another one of the plurality of first magnetic sheets, and
a direction from the one of the plurality of partial regions to the other one of the plurality of partial regions is along the first direction.

### (Technical Proposal 15)

The coil according to any one of Technical proposals 1-14, wherein
the conductive member includes at least one selected from the group consisting of Cu, Al, Ag, and Au, and
the first magnetic sheet includes at least one selected from the group consisting of Fe, Co, Ni, and Mn.

### (Technical Proposal 16)

The coil according to any one of Technical proposals 1-14, wherein
the first magnetic sheet includes ferrite.

### (Technical Proposal 17)

The coil according to any one of Technical proposals 1-16, wherein
a thickness of the first magnetic sheet along the first direction is thinner than a thickness of the first partial region along the first direction.

### (Technical Proposal 18)

The coil according to any one of Technical proposals 1-16, wherein
a thickness of the first magnetic sheet along the first direction is not less than 10 μm and not more than 100 μm, and
a thickness of the first partial region along the first direction is not less than 50 μm and not more than 200 μm.

### (Technical Proposal 19)

The coil according to any one of Technical proposals 1-18, further comprising:
an insulating member,
at least a part of the insulating member being provided between the first partial region and the first sheet region.

### (Technical Proposal 20)

A magnetic component, comprising:
the coil according to any one of Technical proposals 1 to 19; and
a core,
the conductive member being wound around the core, and
the first magnetic sheet being provided around the core.

According to the embodiment, a coil and magnetic component that can reduce loss can be provided.

Hereinabove, exemplary embodiments of the invention are described with reference to specific examples. However, the embodiments of the invention are not limited to these specific examples. For example, one skilled in the art may similarly practice the invention by appropriately selecting specific configurations of components included in the coils and magnetic components such as conductive members and magnetic sheets, etc., from known art. Such practice is included in the scope of the invention to the extent that similar effects thereto are obtained.

Further, any two or more components of the specific examples may be combined within the extent of technical feasibility and are included in the scope of the invention to the extent that the purport of the invention is included.

Moreover, all coils and all magnetic components practicable by an appropriate design modification by one skilled in the art based on the coils and the magnetic components described above as embodiments of the invention also are within the scope of the invention to the extent that the purport of the invention is included.

Various other variations and modifications can be conceived by those skilled in the art within the spirit of the invention, and it is understood that such variations and modifications are also encompassed within the scope of the invention.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the invention.

What is claimed is:

1. A coil, comprising:
a conductive member wound around a first axis as a center,
the conductive member including a first partial region and a second partial region, a first direction from the first partial region to the second partial region being along the first axis; and
a first magnetic sheet including a first sheet region, the first sheet region being provided between the first partial region and the second partial region in the first direction.

2. The coil according to claim 1, wherein
the conductive member further includes a third partial region and a fourth partial region,
the third partial region is provided between the first partial region and the second partial region,
the second partial region is provided between the third partial region and the fourth partial region,
a direction from the third partial region to the fourth partial region is along the first direction,
the first magnetic sheet further includes a second sheet region, and
the second sheet region is provided between the third partial region and the fourth partial region.

3. The coil according to claim 2, wherein
a direction from the third partial region to the first partial region crosses the first direction.

4. The coil according to claim 2, wherein
the first magnetic sheet includes a first end and a first other end,
the conductive member further includes a first intermediate region between the second partial region and the third partial region, and
the first intermediate region is provided between the first end and the first other end.

5. The coil according to claim 2, wherein
a direction from the second sheet region to the first sheet region is substantially perpendicular to the first direction.

6. The coil according to claim 5, wherein
a direction from the third partial region to the second partial region is inclined with respect to the first direction.

7. The coil according to claim 4, wherein
a direction along the third partial region is inclined with respect to a direction along the first intermediate region, and
a direction along the third partial region is substantially parallel to a direction along the second partial region.

8. The coil according to claim 2, wherein
a direction from the second sheet region to the first sheet region is inclined with respect to the first direction.

9. The coil according to claim 4, wherein
a direction along the third partial region is substantially parallel to a direction along the first intermediate region, and
the direction along the first intermediate region is substantially parallel to a direction along the second partial region.

10. The coil according to claim 1, wherein
the first magnetic sheet has an arc shape with the first axis as the center.

11. The coil according to claim 1, further comprising:
a first magnetic member,
the first magnetic member having a cylindrical shape with the first axis as the center,
the conductive member being wound around the first magnetic member in a first plane crossing the first axis, and
the first magnetic sheet being provided around the first magnetic member on the first plane.

12. The coil according to claim 11, wherein
the first magnetic member includes at least one selected from the group consisting of Fe, Co, Ni, and Mn.

13. The coil according to claim 1, wherein
the conductive member includes a plurality of partial regions,
a plurality of the first magnetic sheets are provided, and
the partial region and the first magnetic sheet are alternately provided in the first direction.

14. The coil according to claim 1, wherein
the conductive member includes a plurality of partial regions,
a plurality of the first magnetic sheets are provided,
in the first direction, one of the plurality of partial regions and another of the plurality of partial regions are provided between one of the plurality of first magnetic sheets and another one of the plurality of first magnetic sheets, and
a direction from the one of the plurality of partial regions to the other one of the plurality of partial regions is along the first direction.

15. The coil according to claim 1, wherein
the conductive member includes at least one selected from the group consisting of Cu, Al, Ag, and Au, and
the first magnetic sheet includes at least one selected from the group consisting of Fe, Co, Ni, and Mn.

16. The coil according to claim 1, wherein
the first magnetic sheet includes ferrite.

17. The coil according to claim 1, wherein
a thickness of the first magnetic sheet along the first direction is thinner than a thickness of the first partial region along the first direction.

18. The coil according to claim 1, wherein
a thickness of the first magnetic sheet along the first direction is not less than 10 μm and not more than 100 μm, and
a thickness of the first partial region along the first direction is not less than 50 μm and not more than 200 μm.

19. The coil according to claim 1, further comprising:
an insulating member,
at least a part of the insulating member being provided between the first partial region and the first sheet region.

20. A magnetic component, comprising:
the coil according to claim 1; and
a core,
the conductive member being wound around the core, and
the first magnetic sheet being provided around the core.
